(19) United States
(12) Patent Application Publication
(10) Pub. No.: US 2010/0079565 A1
(43) Pub. Date: Apr. 1, 2010

(54) INK RECOVERY DEVICE

(75) Inventors: Kyoung-Jin Jeong, Suwon-si (KR); Jae-Woo Joung, Suwon-si (KR); Ro-Woon Lee, Seoul (KR); Yong-Sik Kim, Suwon-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/430,478

(22) Filed: Apr. 27, 2009

(30) Foreign Application Priority Data
Sep. 29, 2008 (KR) 10-2008-0095387

(51) Int. Cl. B41J 2/185

(52) U.S. Cl. 347/90

(57) ABSTRACT

An ink recovery device is disclosed. The ink recovery device, configured to retrieve ink being sprayed out from an inkjet printer, in accordance with an embodiment of the present invention includes: a recovery unit, which retrieves the ink; a storage, which is connected to the recovery unit and stores the retrieved ink; and a vibrating unit, which vibrates the stored ink. The ink recovery device in accordance with an embodiment of the present invention can effectively retrieve ink being sprayed out for the maintenance of an inkjet head and immediately reuse the retrieved ink while maintaining the properties of the ink.

### CROSS-REFERENCE TO RELATED APPLICATIONS

This application claims the benefit of Korean Patent Application No. 10-2008-0095387, filed with the Korean Intellectual Property Office on Sep. 29, 2008, the disclosure of which is incorporated herein by reference in its entirety.

### BACKGROUND

1. Technical Field

The present invention relates to an ink recovery device.

2. Description of the Related Art

Inkjet printing is a cost-saving, environment-friendly, process-simplifying technology, and thus has become a popular, new printing technology. Particularly, a variety of attempts have led to new applications in the field of electronics industry as a method that saves time and money in a much more simple and cost-effective way, compared to the conventional photo printing process.

Accordingly, the inkjet printing has become to be used for forming the circuit of a printed circuit board. For forming the circuit by using the inkjet printing, conductive ink is commonly used, and for the conductive ink, metal ink including silver and copper is mainly used. Moreover, catalytic ink of platinum series is used for the characteristics of fuel cell electrodes.

However, maintenance is essential in order to ensure the printing capability of an inkjet printer, and thus the inkjet printer sprays out the ink on a regular basis, and the sprayed ink is discarded of. As a result, expensive metal ink and catalytic ink get wasted.

### SUMMARY

The present invention provides an ink recovery device that can reuse ink being sprayed out from an inkjet head for the maintenance of the inkjet head.

An aspect of the present invention provides an ink recovery device. The ink recovery device, configured to retrieve ink being sprayed out from an inkjet printer, in accordance with an embodiment of the present invention includes: a recovery unit, which retrieves the ink; a storage, which is connected to the recovery unit and stores the retrieved ink; and a vibrating unit, which vibrates the stored ink.

The storage can include a storage bin, which stores the ink, and the vibrating unit can include a medium, which surrounds the storage bin, and a vibration generator, which vibrates the medium.

The recovery unit can include a suction unit, which sucks the sprayed ink into the recovery unit.

The ink recovery device in accordance with an embodiment of the present invention can also include a control valve, which is located in a path between the recovery unit and the storage and controls a flow of the retrieved ink into the storage.

The ink recovery device in accordance with an embodiment of the present invention can also include a filter, which is located in the path between the recovery unit and the storage.

The ink recovery device in accordance with an embodiment of the present invention can also include an ink injection unit, which is coupled to the storage and resupplies the stored ink to the inkjet printer.

The ink recovery device in accordance with an embodiment of the present invention can also include a heater, which heats the stored ink.

Another aspect of the present invention provides an inkjet recovery device. The ink recovery device, configured to retrieve ink being sprayed out from an inkjet printer, in accordance with an embodiment of the present invention includes: a recovery unit, which retrieves the ink; a storage bin, which is connected to the recovery unit and stores the retrieved ink; a medium, which surrounds the storage bin; and a heat generator, which heats the medium.

The recovery unit can include a suction unit, which sucks the sprayed ink into the recovery unit.

The ink recovery device in accordance with an embodiment of the present invention can also include a control valve, which is located in a path between the recovery unit and the storage bin and controls a flow of the retrieved ink into the storage bin.

The ink recovery device in accordance with an embodiment of the present invention can also include a filter, which is located in the path between the recovery unit and the storage bin.

The ink recovery device in accordance with an embodiment of the present invention can also include an ink injection unit, which is coupled to the storage bin and resupplies the stored ink to the inkjet printer.

The ink recovery device in accordance with an embodiment of the present invention can also include a vibration generator, which vibrates the medium.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is an exploded perspective view illustrating an ink recovery device in accordance with an embodiment of the present invention.

FIG. 2 is a cross-sectional view illustrating a vibrator in an ink recovery device in accordance with an embodiment of the present invention.

FIG. 3 is a cross-sectional view illustrating an ink recovery device in accordance with another embodiment of the present invention.

### DETAILED DESCRIPTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

A recovery device in accordance with certain embodiments of the present invention will be described below in more detail with reference to the accompanying drawings. Those components that are the same or are in correspondence are rendered the same reference numeral regardless of the figure number, and redundant explanations are omitted.

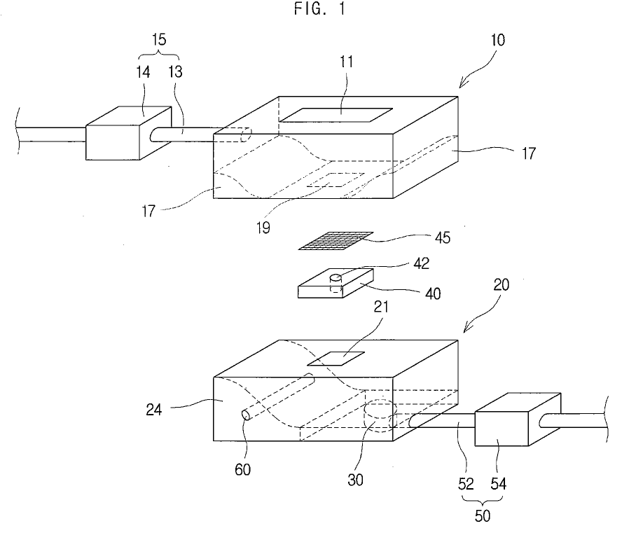

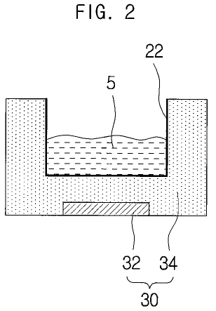

FIG. 1 is an exploded perspective view illustrating an ink recovery device in accordance with an embodiment of the present invention, and FIG. 2 is a cross-sectional view illustrating a vibrator in an ink recovery device in accordance with an embodiment of the present invention.

Illustrated in FIGS. 1 and 2 are ink 5, a recovery unit 10, an aperture 11, a pipe 13, an air pump 14, a suction unit 15, an S-shaped recovery unit slope 17, an outlet 19, a storage 20, an inlet 21, a storage bin 22, an S-shaped storage slope 24, a vibrating unit 30, a vibration generator 32, a medium 34, a control valve 40, a connection hole 42, a filter 45, an ink injection unit 50, a transfer pipe 52, a transfer pump 54 and a heater 60.

The ink recovery device in accordance with an embodiment of the present invention retrieves ink that is sprayed out from an inkjet printer. The ink recovery device includes the recovery unit 10, which retrieves the ink, the storage 20, which is connected to the recovery unit 10 and stores the retrieved ink, and the vibrating unit 30, which vibrates the stored ink, allowing the ink recovery device to reuse the ink being sprayed out for the maintenance of an inkjet head.

The recovery unit 10 retrieves the ink sprayed out for the maintenance of the inkjet head. To do so, a part receiving the ink in the recovery unit 10 can be formed in accordance with the shape of the inkjet head. Referring to FIG. 1, the recovery unit 10 of the ink recovery device in accordance with the present embodiment is shaped like a box, the inside of which is empty, having the aperture 11 corresponding to the shape of the inkjet head. Moreover, the outlet 19, which discharges the recovered ink into the storage unit 20, is formed to connect the recovery unit 10 to the storage 20, which stores the ink. The S-shaped recovery unit slope 17 can be formed on a wall inside the recovery unit 10 such that the ink inside the recovery unit 10 can be easily discharged.

The recovery unit 10 can include the suction unit 15, which sucks the sprayed ink from the inkjet head into the recovery unit 10. Here, some of the ink sprayed out from the inkjet head may remain with the inkjet head and become hardened, blocking a nozzle and thus preventing the nozzle from further spraying. To prevent this, the suction unit 15 can be installed in the recovery unit 10 to take in any residual ink on the inkjet head. The suction unit 15 of the ink recovery device in accordance with the present embodiment includes the pipe 13, which is connected to the recovery unit 10, and the air pump 14, which is connected to the pipe 13. Accordingly, the air pump 14 sucks out the air that is inside the recovery unit 10 and creates negative pressure in the recovery unit 10, allowing the recovery unit 10 to suck in the residual ink from the inkjet head.

In a path between the recovery unit 10 and the storage 20, the control valve 40, which is used to control the flow of ink from the recovery unit 10 to the storage 20, can be further included. As described above, if negative pressure is created in the recovery unit 10, the control valve 40 can close the connection hole 42, which connects the recovery unit 10 to the storage 20, in order to block the path to the storage unit 20. After the ink is sucked in, the connection hole 42 can be opened, allowing the ink to flow into the storage 20.

In the path between the recovery unit 10 and the storage 20, the filter 45, which is used to remove impurities contained in the ink, can be installed. In the ink recovery device in accordance with the present embodiment, the filter 45 can be interposed between the recovery unit 10 and the control valve 40.

The storage 20 stores the ink retrieved from the recovery unit 10. To do this, the storage 20 is connected to the recovery unit 10, and a space is formed to store the ink 5. Referring to FIG. 1, the inlet 21, which is connected to the outlet 19 of the recovery unit 10, is formed on the storage 20 of the ink recovery device in accordance with the present embodiment. Then, the S-shaped storage slope 24 is formed on an inner wall in order to easily collect the ink that is flowed in. Referring to FIG. 2, the storage bin 22 is formed to collect and store the retrieved ink.

The vibrating unit 30 vibrates the ink 5 stored in the storage 20. In case the ink 5 is easily coagulated due to particles included in the ink 5, as in metal ink, the vibrating unit 30 vibrates the ink 5 in order to prevent the retrieved ink from being coagulated. To do so, a wall surrounding the ink 5 can be vibrated by using the vibration generator 32, for example, a sonicator, or the ink 5 can be vibrated by immersing a vibration generator that is in a shape of a prove in a space where the retrieved ink 5 is stored.

In order to deliver the vibration evenly to the stored ink 5, the storage 20 can include the storage bin 22, and the vibrating unit 30 can include the medium 34 surrounding the storage bin 22 and the vibration generator 32 vibrating the medium 34. Referring to FIG. 2, the vibrating unit 30 of the ink recovery device in accordance with the present embodiment has a liquid-state medium surrounding the storage bin 22 and the vibration generator 32 that is positioned in the liquid-state medium and vibrates the liquid-state medium. While the vibration generated by the vibration generator is evenly delivered to the storage bin 22 through the liquid-state medium 34, the vibration can be evenly transferred to the stored ink 5. Therefore, the particles included in the ink 5 can be evenly distributed. While the present embodiment presents an example of passing the vibration by the liquid-state medium, it is apparent that the medium 34 is not limited to the liquid state and includes all mediums that can evenly transfer the vibration.

The ink recovery device can also include the heater 60, which heats the stored ink 5. The stored ink 5 may be hardened due to a drop in temperature while being stored. To prevent this, the heater 60 can be installed in the storage 20 to prevent the temperature of the ink 5 from falling. The ink recovery device in accordance with the present embodiment can constantly maintain the temperature of the ink 5 by mounting the heater 60, made with heating wires, in the storage 20.

Furthermore, the ink recovery device can be coupled to the storage 20 and also include the ink injection unit 50, which supplies the stored ink 5 to the inkjet printer. As described above, the impurities contained in the retrieved ink is removed by the filter 45, and the ink with the impurities removed can maintain its properties by the vibrating unit 30 and the heater 60. Therefore, the stored ink 5 can be reused immediately.

Accordingly, the ink injection unit 50 can supply the retrieved ink to the inkjet printer. The ink injection unit 50 in accordance with the present embodiment includes the transfer pipe 52, which is connected to the storage bin 22, and the transfer pump 54, which supplies the ink 5 to the inkjet head. As a result, the ink 5 stored in the storage bin 22 can be immediately reused.

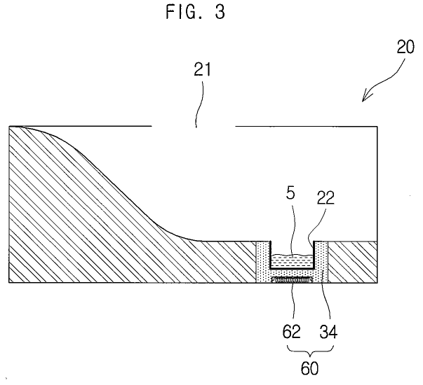

FIG. 3 is a cross-sectional view illustrating an ink recovery device in accordance with another embodiment of the present invention.

Illustrated in FIG. 3 are ink 5, a storage 20, an inlet 21, a storage bin 22, a medium 34, a heater 60 and a heat generator 62.

The ink recovery device in accordance with the present embodiment is the same as that of the first embodiment described above except that the storage bin 22 is heated through the medium 34.

The ink recovery device in accordance with the present embodiment includes the recovery unit 10, the storage bin 22, which is connected to the recovery unit 10 and stores the retrieved ink 5, the medium 34, which surrounds the storage bin 22, and the heat generator 62, which heats the medium 34.

Referring to FIG. 3, the ink recovery device in accordance with the present embodiment includes the heat generator 62, which heats the liquid-state medium 34 surrounding the storage bin 22. As a result, the heat generated from the heat generator 62 can be evenly transferred to the storage bin 22 through the medium 34. Therefore, the heat is evenly distributed to the stored ink, preventing the ink 5 from being hardened.

The ink recovery device in accordance with the present embodiment can also include a vibration generator. As described above, the vibration generator is used for vibrating the medium 34 in order to evenly deliver the vibration to the ink.

Other elements are already described above, and thus the description thereof will be omitted.

While the spirit of the invention has been described in detail with reference to certain embodiments, the embodiments are for illustrative purposes only and shall not limit the invention. It is to be appreciated that those skilled in the art can change or modify the embodiments without departing from the scope and spirit of the invention. As such, many embodiments other than those set forth above can be found in the appended claims.

What is claimed is:

1. An ink recovery device configured to retrieve ink being sprayed out from an inkjet printer, the ink recovery device comprising:
a recovery unit configured to retrieve the ink;
a storage connected to the recovery unit and configured to store the retrieved ink; and
a vibrating unit configured to vibrate the stored ink.

2. The ink recovery device of claim 1, wherein:
the storage comprises a storage bin configured to store the ink; and
the vibrating unit comprises a medium surrounding the storage bin and a vibration generator configured to vibrate the medium.

3. The ink recovery device of claim 1, wherein the recovery unit comprises a suction unit configured to suck the sprayed ink into the recovery unit.

4. The ink recovery device of claim 1, further comprising a control valve located in a path between the recovery unit and the storage and configured to control a flow of the retrieved ink into the storage.

5. The ink recovery device of claim 1, further comprising a filter located in the path between the recovery unit and the storage.

6. The ink recovery device of claim 1, further comprising an ink injection unit coupled to the storage for resupplying the stored ink to the inkjet printer.

7. The ink recovery device of claim 1, further comprising a heater configured to heat the stored ink.

8. An ink recovery device configured to retrieve ink being sprayed out from an inkjet printer, the ink recovery device comprising:
a recovery unit configured to retrieve the ink;
a storage bin connected to the recovery unit and configured to store the retrieved ink;
a medium surrounding the storage bin; and
a heat generator configured to heat the medium.

9. The ink recovery device of claim 8, wherein the recovery unit comprises a suction unit sucking the sprayed ink into the recovery unit.

10. The ink recovery device of claim 8, further comprising a control valve located in a path between the recovery unit and the storage bin and configured to control a flow of the retrieved ink into the storage bin.

11. The ink recovery device of claim 8, further comprising a filter located in the path between the recovery unit and the storage bin.

12. The ink recovery device of claim 8, further comprising an ink injection unit coupled to the storage bin for resupplying the stored ink to the inkjet printer.

13. The ink recovery device of claim 8, further comprising a vibration generator configured to vibrate the medium.
